(19) United States
(12) Patent Application Publication
(10) Pub. No.: US 2017/0264658 A1
(43) Pub. Date: Sep. 14, 2017

(54) METHOD FOR DISTRIBUTING FRAME DATA OF IMAGE

(71) Applicant: FUJITSU LIMITED, Kawasaki-shi (JP)

(72) Inventors: Daichi SHIMADA, Kawasaki (JP); Masayoshi HASHIMA, Kawasaki (JP)

(73) Assignee: FUJITSU LIMITED, Kawasaki-shi (JP)

(21) Appl. No.: 15/606,548

(22) Filed: May 26, 2017

Related U.S. Application Data
(63) Continuation of application No. PCT/JP2014/082225, filed on Dec. 5, 2014.

(51) Int. Cl. H04L 29/06

(52) U.S. Cl. CPC H04L 65/4092; H04L 65/80; H04L 67/42

(57) ABSTRACT

A method for distributing frame data of an image to a plurality of clients via a network, the method including generating, using a processor, first frame data and second frame data as the frame data, transmitting, using the processor, the first frame data to all of the plurality of clients, and transmitting, using the processor, the second frame data to clients for whom a communication environment between the clients and the server satisfies a predetermined condition between the transmissions of the first frame data.

### CROSS-REFERENCE TO RELATED APPLICATION

This application is a continuation application of International Application PCT/JP2014/082225 filed on Dec. 5, 2014 and designated the U.S., and the entire contents of which are incorporated herein by reference.

### FIELD

Disclosure relates to a method for distributing frame data of image.

### BACKGROUND

As one of collaboration systems, there is a system that transfers (distributes) a server screen to a plurality of clients (also referred to as “users”) so that the screen is shared among the plurality of clients. The server, for example, captures a screen and transmits the still image data obtained to each client at a predetermined frame rate (the number of frames per unit time). Each client enters operation information of the screen using an input device and transmits the operation information to the server. The server updates the screen based on the operation information and distributes frame data of the updated screen to each client. In this way, operators of the plurality of clients can operate one screen.

For further information, refer to Japanese Patent Laid-Open Publication No. 2009-110041, Japanese Patent Laid-Open Publication No. 9-204380, and Japanese Patent Laid-Open Publication No. 2005-267347.

### SUMMARY

However, a network environment (communication environment) that connects each client and the server may be non-uniform among clients. For example, when there is a variation in bands available for communication among the clients, there may be differences in timing of receiving frame data and screen display (update) timing among the clients.

In view of the above problems, a frame rate may be changed for each client (for each communication environment common to several clients). In this case, a screen is captured, frame data is generated, and the frame data is transmitted at timing differing from one client (communication environment) to another. This results in a problem that as the number of clients (communication environments) increases, processing load of the server increases.

An aspect of embodiments is a method for distributing frame data of an image to a plurality of clients via a network, the method including generating, using a processor, first frame data and second frame data as the frame data, transmitting, using the processor, the first frame data to all of the plurality of clients, and transmitting, using the processor, the second frame data to clients for whom a communication environment between the clients and the server satisfies a predetermined condition between the transmissions of the first frame data.

The target and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of a network system constituting a collaboration system in which an image is shared among users;

FIG. 2 illustrates an example of a method for transmitting screen data according to Embodiment 1;

FIG. 3 is a diagram illustrating an example of a method for determining key frames;

FIG. 4 is a diagram schematically illustrating an example of key frame transmission control on each client;

FIG. 5 is a flowchart illustrating an example of the transmission determination processing illustrated in FIG. 4;

FIG. 6 illustrates a hardware configuration example of an information processing apparatus (computer) usable as the server and each client illustrated in FIG. 1;

FIG. 7 is a diagram schematically illustrating a configuration example of the server;

FIG. 8 is a diagram schematically illustrating a configuration example of a client;

FIG. 9 is a flowchart illustrating a processing example of the server;

FIG. 10 illustrates a data structure example of a response time list;

FIG. 11 is a flowchart illustrating a processing example of the client;

FIG. 12A is a diagram illustrating Embodiment 2;

FIG. 12B is a diagram illustrating Embodiment 2;

FIG. 13 is a flowchart illustrating a processing example of a server according to Embodiment 2;

FIG. 14 illustrates a data structure example of a response time list according to Embodiment 2;

FIG. 15 is a flowchart illustrating a processing example of a client according to Embodiment 2;

FIG. 16 is a diagram schematically illustrating a configuration example of a server according to Embodiment 3;

FIG. 17 is a flowchart illustrating a processing example of a server according to Embodiment 3;

FIG. 18A illustrates an example of registration contents of a corrected response time list; and

FIG. 18B illustrates an example of registration contents of a corrected response time list.

### DESCRIPTION OF EMBODIMENTS

Hereinafter, embodiments will be described with reference to the accompanying drawings. Configurations of the embodiments are presented by way of example and the present invention is not limited to the configurations of the embodiments.

### Embodiment 1

### Network System

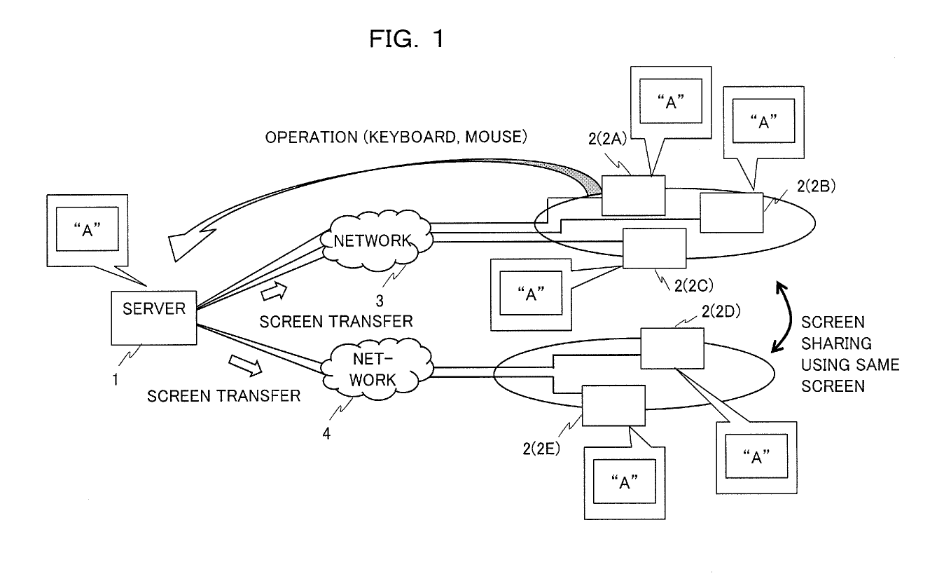

FIG. 1 illustrates a configuration example of a network system constituting a collaboration system according to an embodiment. In the embodiments, a server applied to the collaboration system in which an image is shared among clients (also called “users”) and a method for distributing server image data will be described.

In FIG. 1, the network system includes a server 1 and a plurality of clients 2 (2A to 2E). In the following description, when the clients 2A to 2E are not distinguished from one another, they are expressed as “client 2.” The clients 2A to 2C are connected to the server 1 via a network 3 and the clients 2D and 2E are connected to the server 1 via a network 4. The network 3 and network 4 may include a wireless section.

The server 1 stores image data to be shared among the clients 2 (users) and an image editing program. The server 1 generates compressed data obtained by compressing a bitmap (still image data) of an image editing screen (screen including images to be edited) based on a predetermined codec format and distributes the compressed data to each client 2 as frame data. Examples of the codec format include Joint Photographic Experts Group (JPEG), JPEG XR, Graphics Interchange Format (GIF), Portable Network Graphics (PNG), but the codec format is not limited to them. Each client 2 performs reconstruction processing on the compressed screen data and displays a screen based on the screen data on a display. A common screen is displayed on a display of each client 2. The screen is an example of an “image.”

Each client 2 is provided with an interface common among the clients 2 for editing (processing) images displayed on a screen. The interface is an input device including a pointing device such as a keyboard or mouse. An operator of the client 2 performs operation input for editing images using the input device. Information inputted by the operation input (referred to as “operation information”) is transmitted to the server 1 via a network (network 3 or network 4). The operation information includes information on editing as well as operation associated with changes in a display mode such as movement or rotation of an image within a screen.

Upon receiving the operation information, the server 1 updates (image editing, change of display mode or the like) of screen data using the operation information by executing an image data editing program. The server 1 compresses the updated screen data and transmits it to each client 2. The updated screen is thereby displayed on the display of each client 2.

Thus, the plurality of clients 2 share the screen data and a result (response to the operation) of the operation (image editing, change of display mode) performed on the screen data by any one client 2 is also reflected on the other clients 2. An image within a screen is, for example, a design drawing of a machine or electronic device and a common design drawing can be edited by a plurality of users. However, contents of images are not limited to design drawings but include all kinds of images. Note that an “image” is a concept that includes both still images and moving images. Examples of the codec format for moving images include H.263, H.264, Moving Picture Experts Group (MPEG), but the codec format is not limited to them.

### Method for Transmitting Screen Data

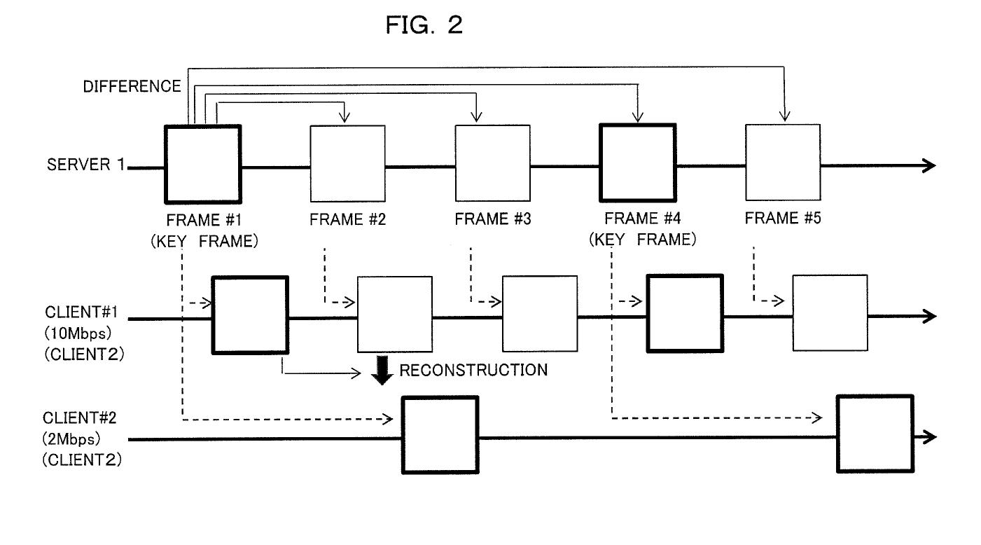

Next, a method for transmitting screen data of the server according to Embodiment 1 (an example of “method for distributing a server image”) will be described. FIG. 2 illustrates an example of the method for transmitting screen data according to Embodiment 1. In FIG. 2, an arrow of thick line represents a time axis. A rectangle of thick line represents a key frame and a rectangle of thin line represents a non-key frame (difference image). An arrow of thin line indicates that a frame is a difference image of frame #1. An arrow of thin broken line represents transmission timing and delay of a frame.

The server 1 distributes frame data of an image to the plurality of clients 2. The frame data is transmitted to each client 2 at transmission timing according to a predetermined frame rate. The server 1 generates a number of pieces of frame data according to the frame rate. The client 2 reconstructs an image through reconstruction processing using frame data received from the server 1 and can display the reconstructed image on the display.

The frame data includes a key frame and a non-key frame. The key frame is frame data transmitted to all of the clients 2. The non-key frame is frame data that is transmitted between key frame transmissions or transmission of which is canceled (thinned out) in accordance with a communication environment between the client 2 and the server 1. The key frame is an example of “first frame data” and the non-key frame is an example of “second frame data.”

In the example in FIG. 2, frames #1 to #5 are illustrated as frame data generated by the server 1. Of the frame #1 to frame #5, the frame #1 and frame #4 are key frames. On the other hand, the frame #2, frame #3 and frame #5 are non-key frames.

In the example in FIG. 2, client #1 and client #2 are illustrated as an example of the plurality of clients 2. The client #1 is, for example, one of clients 2A, 2B and 2C connected to the network 3 and the client #2 is one of clients 2D and 2E connected to the network 4.

A network environment (communication environment) of the client #1 is different from that of the client #2. That is, the network 3 is different from the network 4 in a band available to transfer frame data. For example, while a band (communication speed) available to the client #1 is 10 Mbps, a band (communication speed) available to the client #2 is 2 Mbps. In other words, the client #1 has a communication environment having a broader band than that of the client #2.

The server 1 changes transmission contents for the clients in accordance with the communication environments of the client #1 and the client #2. As described above, the frame #1 and frame #4 which are key frames are transmitted to all of the clients 2 (client #1 and client 2). On the contrary, transmissions of the frame #2, frame #3 and frame #5 which are non-key frames are carried out or canceled (thinned out) depending on whether or not the communication environment between the client 2 and the server 1 satisfies a predetermined condition.

In the example illustrated in FIG. 2, it is determined that there are bands available to transmit the frame #2, frame #3 and frame #5 for the client #1 (that is, the communication environment satisfies a predetermined condition) and the frame #2, frame #3 and frame #5 are transmitted to the client #1. In contrast, it is determined that there are no bands available to transmit the frame #2, frame #3 and frame #5 for the client #2 (that is, the communication environment does not satisfy the predetermined condition) and transmissions of the frame #2, frame #3 and frame #5 are canceled for the client #2. That is, the frame #2, frame #3 and frame #5 are thinned out.

By such transmission control on frame data by the server 1, it is possible to perform integrated transmission control on frame data for all of the clients 2. That is, at least key frames are transmitted to each client 2. For this reason, each client 2 can display images based on the key frames on the display. It is thereby possible to guarantee that the same image is displayed among all of the clients 2.

On the other hand, since non-key frames are thinned out in accordance with the communication environment of the client 2, frame data can be transmitted to each client 2 at a frame rate in accordance with the communication environment of the client 2. Therefore, compared to conventional cases where frame data that differs from one client or communication environment to another is generated and transmitted, it is possible to reduce processing load of the server 1.

Frame data is generated by compressing screen data obtained by capturing a screen (bitmap: also referred to as a “captured image”). The frame data obtained by compressing the whole captured image is called “compressed image.” In contrast, a difference from a past compressed image is called a “difference image.” The difference image is obtained by extracting difference data between captured images and compressing the difference data.

Since the compressed image is data obtained by compressing a whole captured image, the client 2 can reconstruct the captured image (image data) from a compressed image alone. In contrast, when the client 2 receives a difference image, it reconstructs the captured image (screen data) by referencing (synthesizing) past compressed images. The compressed image corresponds to a so-called I picture (intra-picture: also referred to as “I frame”) and the difference image corresponds to a so-called P picture (predictive picture: “P frame”).

Compressed images are also applicable to all frame data. However, in Embodiment 1, a compressed image is applied to frame data (key frame: frame #1) transmitted at the first time and difference images are applied to the frame data (frame #2, #3, . . . ) from the next time.

In this case, the client 2 uses the frame #1 in reconstruction processing onscreen data using frame data from frame #2 onward. A data amount (size) of a difference image is smaller than a data amount (size) of a compressed image. For this reason, by applying difference images to the frame data from the next time, it is possible to reduce the amount of transfer data for the client 2.

However, such a modification may be adopted that compressed images are applied to key frames to be transmitted from the second time. For example, a compressed image may be applied to the frame #4. In this case, the server 1 generates and transmits a difference image of the frame #4 as the frame #5. In this way, the client 2 can reconstruct image data using the frame #5 and frame #4, instead of reconstructing image data using the frame #5. In other words, it is possible to use the last received key frame to reconstruct the image data using a non-key frame. Note that a compressed image may be applied to at least one key frame received from the second time on.

The longer the elapsed time after the time of generation of an image to be referenced for reconstructing data becomes, the larger the difference from the image possibly becomes. An increase in the difference means an increase in the size of the difference image. Through the above modification, it is possible to expect that the data amount (size) of the non-key frame (frame #5) transmitted after transmissions of the second and subsequent key frames (e.g., frame #4) be decreased.

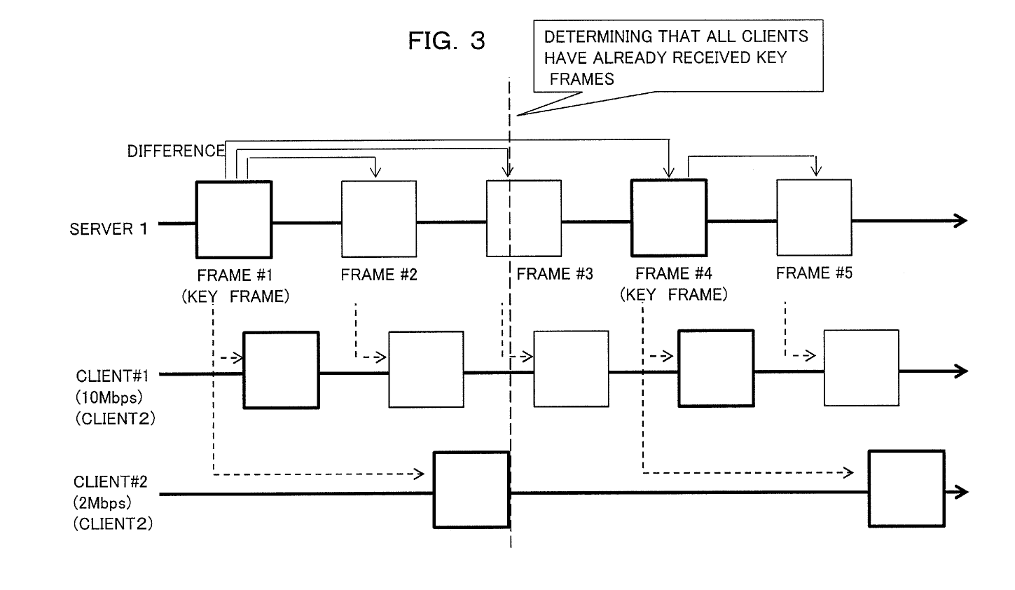

Transmission timings of key frames after the first time (e.g., frame #4) can be determined as follows. FIG. 3 is a diagram illustrating an example of the method for determining a key frame. After transmitting frame data of the initial key frame (frame #1), the server 1 transmits the next and subsequent frame data at timing according to a predetermined frame rate. The frame rate (length of a predetermined interval (predetermined time)) can be set as appropriate; may be fixed or made variable depending on the situation.

Upon detecting that key frames have been received by all of the clients 2, the server 1 determines to transmit a key frame at transmission timing of the next frame data. When a difference image is applied to the second and subsequent frame data, the server 1 sets the frame data (difference image) transmitted at transmission timing of the above next frame data in the key frame. In contrast, when compressed images are applied to all the key frames, the server 1 generates a compressed image of the image data and transmits it at transmission timing of the above next frame data.

In the example illustrated in FIG. 3, at a certain point in time after the transmission timing of the frame #3 and before the transmission timing of the frame #4 (see a broken line in FIG. 3), it is detected that all of the clients 2 (client #1 and #2) have received an immediately preceding key frame (frame #1). In this case, the key frame is transmitted at transmission timing of the next frame data (frame #4).

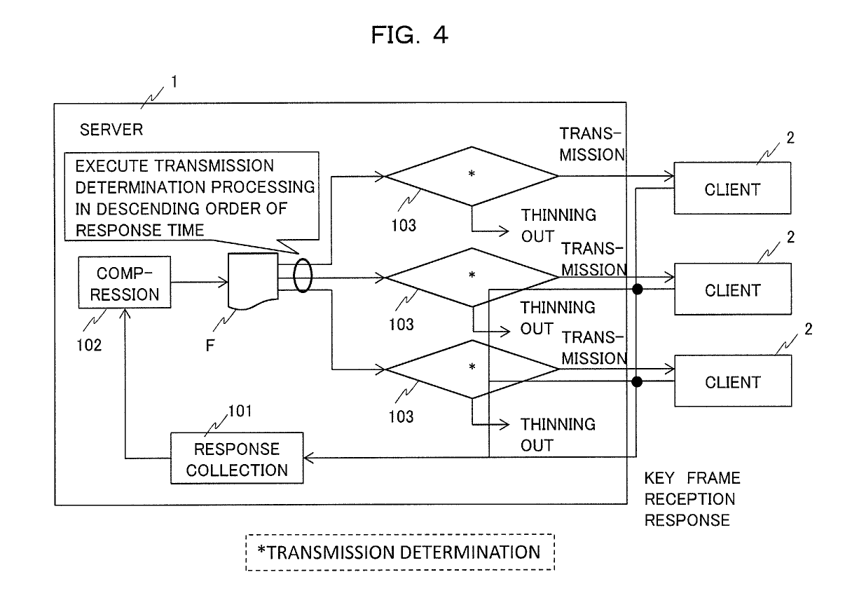

For example, the server 1 measures a delay in the network that connects the server 1 and each client 2, and can thereby determine reception of a key frame based on the delay. FIG. 4 is a diagram schematically illustrating an example of frame transmission control on each client 2. In FIG. 4, the server 1 receives a response message (hereinafter referred to as “reception response”) indicating reception of a key frame from the client 2 (user) who has received the key frame. FIG. 4 illustrates an example where the number of clients is 3. The server 1 performs a collection process 101 of collecting a reception response of a key frame and a compression process 102 of generating a compressed image and a difference image (key frame and non-key frame).

The collection process 101 collects a reception response from each client 2. After collecting the reception responses from all of the clients 2, the collection process 101 transmits information indicating receptions of key frames of all of the clients 2 (hereinafter referred to as a “reception report”)) to the compression process 102. The compression process 102 generates and outputs frame data (see reference character “F” in FIG. 4) in accordance with the frame rate.

For example, when the above signal is received, the compression process 102 assigns an identifier indicating a key frame to the frame data to be outputted next. When there is no such signal, the compression process 102 does not assign any identifier to the frame data to be outputted next or assigns an identifier indicating a non-key frame. However, it is also possible to assign an identifier to a non-key frame instead of assigning an identifier to a key frame.

Note that the reception report may be supplied to a transmission determination process 103 which will be described later and the transmission determination process 103 may determine whether the transmission target is a key frame or non-key frame. In this case, assignment of identifiers does not always be needed.

The server 1 executes transmission processing on each client 2. The transmission processing on each client 2 is executed in descending order of response time between the client 2 and the server 1. For example, the server 1 measures a round trip time (RTT) after transmitting a key frame until receiving a reception response to/from each client 2 as a response time. A greater response time (delay) means a not good communication environment (e.g., far from the server 1 or available band is small). Executing transmission processing in descending order of response time makes it possible to bring closer (make uniform) display timings of screens based on the key frame between the clients 2.

In the transmission processing on each client 2, the transmission determination process 103 is performed on the frame data to be transmitted. In the transmission determination process 103, if the frame data (transmission data) to be transmitted is a key frame, transmission to the client 2 is performed. In contrast, if the frame data to be transmitted is a non-key frame, transmission to the client 2 is performed, for example, on condition that there is an available band in the communication channel to the client 2. If there is no available band, transmission of a difference image is canceled (that is, the non-key frame is thinned out).

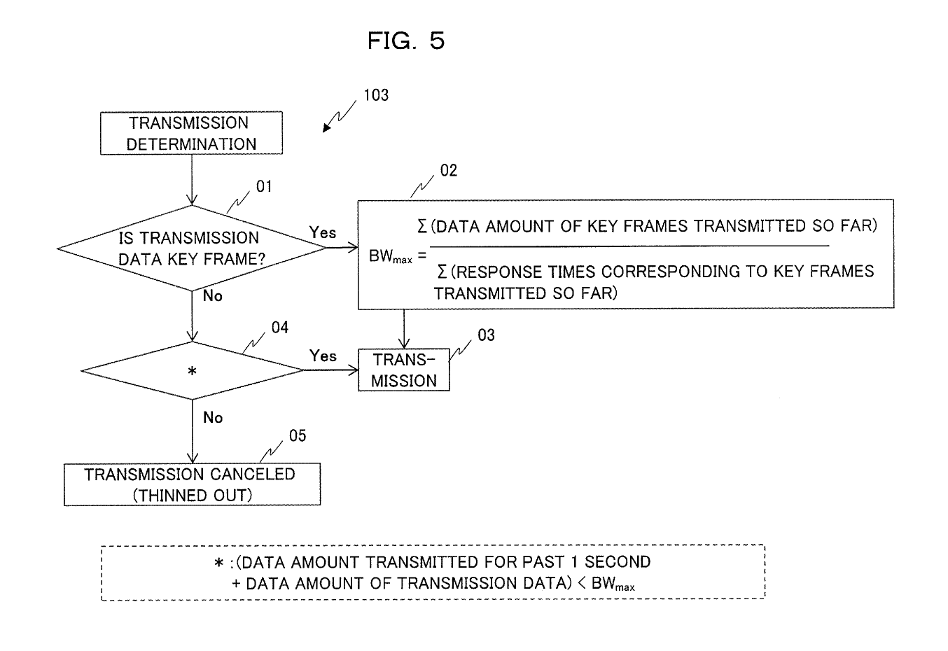

FIG. 5 is a flowchart illustrating an example of the transmission determination process 103 illustrated in FIG. 4. In 01 in FIG. 5, it is determined whether or not the transmission data (frame data to be transmitted) is a key frame. This determination is made, for example, based on whether or not the transmission data includes an identifier indicating that the transmission data is a key frame. However, as described above, the determination in 01 may also be made depending on whether or not a reception report has arrived from the collection process 101.

When the transmission data is a key frame (01, Yes), an estimate value of an available band BWₘₐₓ relating to the client 2 is calculated according to the following calculation expression (02). After that, a key frame is transmitted (03).

BWₘₐₓ=Σ (data amount of key frames transmitted so far)/Σ (response times corresponding to key frames transmitted so far)

The available band BWₘₐₓ represents a data amount per unit time available to transmit frame data. The unit time is, for example, 1 second, but other time lengths may also be used. Note that in the server 1, the data amount (size) of each key frame and round trip time are recorded in the main storage device 12 or auxiliary storage device 13 at any time, and are used to calculate the available band BWₘₐₓ in the processing in 03.

When the transmission data is not a key frame in 01 (when the transmission data is a non-key frame: 01, No), it is determined whether or not the sum of the data amount transmitted for past one second and the data amount transmitted this time is less than the available band BWₘₐₓ (04). At this time, if the sum is less than the available band BWₘₐₓ (04, Yes), a non-key frame is transmitted (03). In contrast, when the sum is equal to or greater than the available band BWₘₐₓ (04, No), transmission of the non-key frame is canceled. That is, the non-key frame is thinned out.

As described above, when the transmission data is a key frame, the key frame is transmitted in the transmission determination process 103. Therefore, the key frame is periodically transmitted to all of the clients 2. In contrast, in the case of a non-key frame, transmission processing on the non-key frame is performed if there is a band available for transmission of the non-key frame (if the transmission data amount does not reach the available band BWₘₐₓ).

As illustrated in FIG. 4, by returning a reception response to the server 1 every time each client 2 (user) receives a key frame, it is possible to perform transmission control in nearly real-time (quasi-real-time).

When receptions of key frames are detected at all of the clients 2, by setting frame data to be transmitted next in the key frame, it is possible to avoid the time length between key frames from being unnecessarily extended and it can be expected to reduce a difference between neighboring key frames. In other words, it can be expected to reduce a variation of the screen displayed at the client 2 having a narrow band.

Furthermore, by calculating an estimate value of the above available band BWₘₐₓ, it is possible to cause, when the communication environment changes as the time passes, a threshold (available band BWₘₐₓ) for determining whether or not it is possible to transmit a non-key frame to follow the variation of the communication environment. However, the threshold of the available band may be fixed.

Note that a plurality of clients 2 exist at the same site. When, for example, a plurality of clients 2 (e.g., clients 2A, 2B and 2C illustrated in FIG. 1) are accommodated in the same network (Local Area Network: LAN), transmission data may be transmitted by broadcasting. By so doing, it is possible to further reduce the amount of transfer data. Hereinafter, details of the above server 1 and each client 2 will be described.

### Hardware Configuration of Information Processing Apparatus

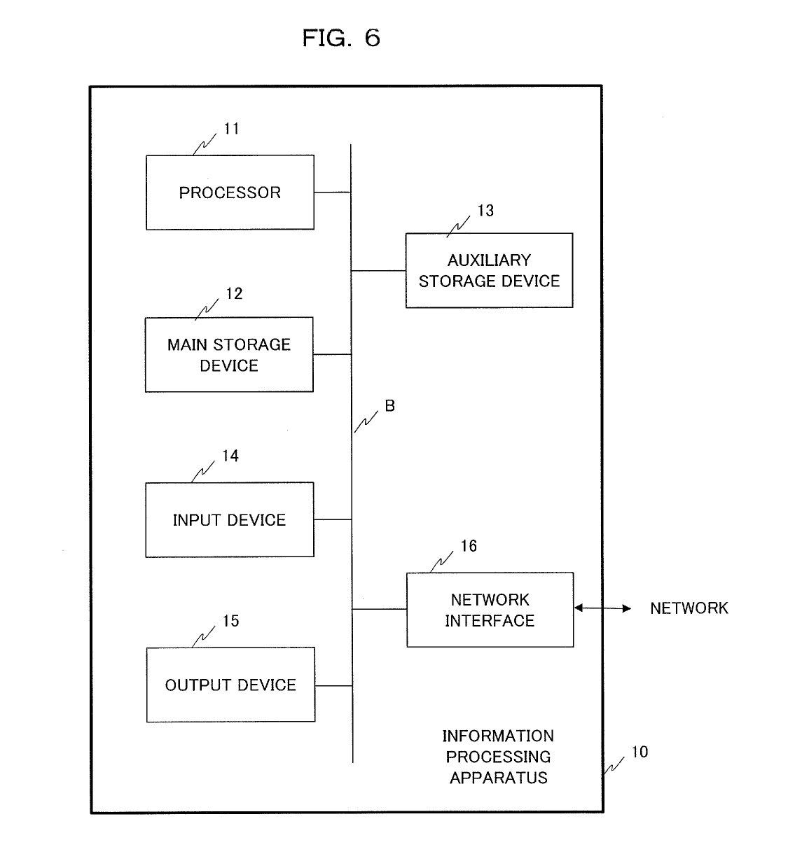

FIG. 6 illustrates a hardware configuration example of an information processing apparatus (computer) usable as the server 1 and each client 2 illustrated in FIG. 1. An information processing apparatus 10 includes a processor 11, a main storage device 12, an auxiliary storage device 13, an input device 14, an output device 15 and a network interface (NIF) 16, all of which are interconnected via a bus B.

The processor 11 is a general-purpose processor which is at least one selectable from among a central processing unit (CPU), digital signal processor (DSP) and graphics processing unit (GPU) or the like. However, a dedicated processor is also applicable as the processor 11. An example will be described below where the processor 11 is a CPU.

The main storage device 12 is an example of a main storage device (main memory) and includes, for example, a read only memory (ROM) and a random access memory (RAM). The main storage device 12 is used as a work area of the processor 11.

The auxiliary storage device 13 stores various programs executed by the processor 11 (operating system (OS), application program) and data used when executing a program. As the auxiliary storage device 13, at least one selectable from among a hard disk drive (HDD), electrically erasable programmable read-only memory (EEPROM), flash memory and solid state drive (SSD) or the like can be used. The auxiliary storage device 13 includes a disk storage medium and a drive apparatus thereof.

The input device 14 includes at least one of buttons, keys, keyboard and pointing device such as mouse and touch panel, and is used to input information and data. The input device 14 includes a speech input device (microphone).

The output device 15 includes a display apparatus (display). The output device 15 can also include a speech output device (speaker) or a printing apparatus (printer). Furthermore, a lamp or vibrator can be included as the output device 15.

The NIF 16 is an interface circuit that administers communication processing with a communication device connected via a network. As the NIF 16, for example, a local area network (LAN) card or network interface card (NIC) is applicable.

The processor 11 performs various functions by loading a program stored in the auxiliary storage device 13 into the main storage device 12 and executing the program. By performing such functions, the information processing apparatus 10 can operate as the server 1 or client 2.

Note that some or all of the functions executed by the processor 11 may be mounted by a hardware logic (wired logic) of hardware. Examples of hardware include at least one of electric/electronic circuit, integrated circuit (IC), large scale integrated circuit (LSI) and application specific integrated circuit (ASIC). Examples of hardware include programmable logic device (PLD) such as field programmable gate array (FPGA). In this case, one hardware unit may execute a plurality of functions or one function may be executed by a combination of a plurality of hardware units.

The processor 11 is an example of a “processor,” “control apparatus,” or “controller.” Furthermore, the main storage device 12 and the auxiliary storage device 13 are each an example of a “storage device,” “memory” or “computer-readable recording medium.”

### Configuration of Server

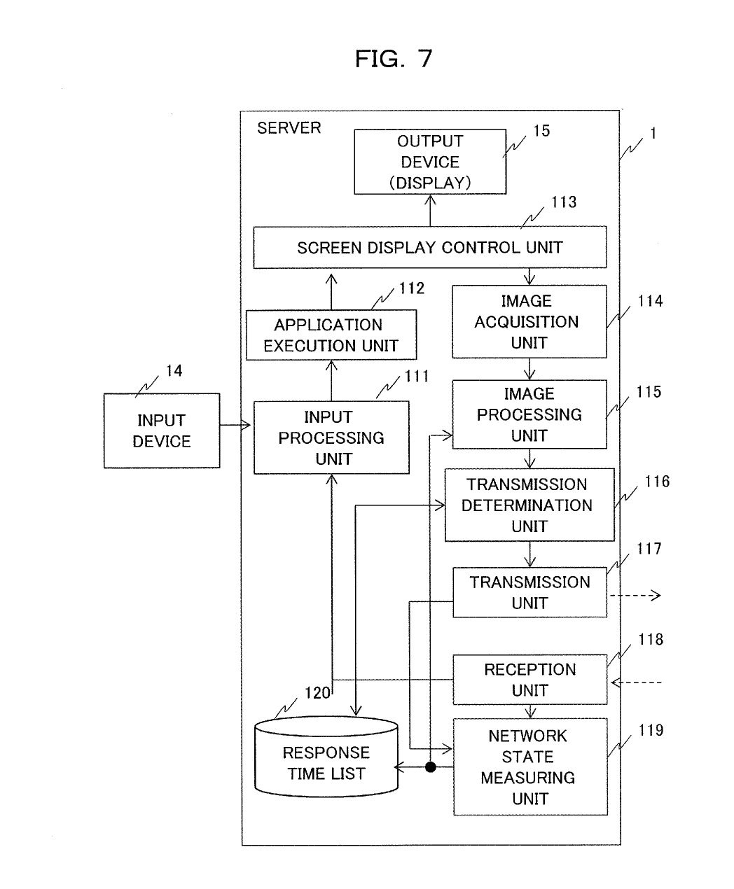

FIG. 7 is a diagram schematically illustrating a configuration example of the server 1. In FIG. 7, the information processing apparatus 10 (FIG. 6) that operates as the server 1 operates as an apparatus including blocks illustrated in FIG. 7 when the processor 11 executes a program. In FIG. 7, the server 1 includes an input processing unit 111 connected to the input device 14, an application execution unit 112 connected to the input processing unit 111 and a screen display control unit 113 connected to the application execution unit 112 and the output device 15 (display).

The server 1 includes an image acquisition unit 114 connected to the screen display control unit 113, an image processing unit 115 connected to the image acquisition unit 114 and a transmission determination unit 116 connected to the image processing unit 115. The server 1 further includes a transmission unit 117 connected to the transmission determination unit 116 and a network, a reception unit 118 connected to the network, a network state measuring unit 119 connected to the reception unit 118 and a response time list 120.

The input processing unit 111, the application execution unit 112, the screen display control unit 113, the image acquisition unit 114, the image processing unit 115, and the transmission determination unit 116 and the reception measuring unit 119 are functions of the processor 11 obtained when the processor 11 (e.g., CPU) of the information processing apparatus 10 illustrated in FIG. 6 executes the program. The transmission unit 117 and the reception unit 118 are functions of the NIF 16. The response time list 120 is created on the main storage device 12 or the auxiliary storage device 13.

The input processing unit 111 processes information or data inputted from the input device 14 and the reception unit 118. The application execution unit 112 executes an application program (program for image editing or the like) and performs processing based on the inputted information. For example, the input processing unit 111 acquires operation information of the screen from the client 2 received by the reception unit 118 and distributes the operation information to the application execution unit 112.

The application execution unit 112 changes drawing parameters of the screen displayed, for example, on the output device 15 using the operation information. The screen display control unit 113 draws screen data displayed on the output device 15 (display) on a VRAM (video RAM) and sends a video signal of the screen data to the output device 15. The VRAM is included in the main storage device 12. The output device 15 (display) displays a screen based on the screen data.

The image acquisition unit 114 acquires (captures) the screen data drawn by the screen display control unit 113 at, for example, timing that matches the frame rate. The image processing unit 115 performs compression process 102 (FIG. 4), generates frame data (compressed image and difference image) from the screen data and outputs the frame data. When a reception report is received, the image processing unit 115 assigns an identifier indicating a key frame to the frame data to be outputted next.

The transmission determination unit 116 executes the transmission determination process 103 (FIG. 4, FIG. 5). Data for calculation of the available band BWₘₐₓ of each client 2 used for the transmission determination process 103 is stored in the main storage device 12 or auxiliary storage device 13. The transmission unit 117 receives a key frame and a difference image to be transmitted and transmits them to the destination. The reception unit 118 receives the operation information from the client 2 and sends the operation information to the input processing unit 111 or receives a reception response and sends the reception response to the reception measuring unit 119.

The measuring unit 119 measures a response time (RTT) of each client 2. For example, the measuring unit 119 receives a transmission time of key frame for each client 2 from the transmission unit 117. On the other hand, the measuring unit 119 performs the collection process 101 of collecting a reception response to a key frame received by the reception unit 118 and obtains a reception time of the reception response. The measuring unit 119 obtains a response time (RTT) from a difference between the transmission time and the reception time. A response time of each client 2 is stored in the response time list 120. With reference to the response time list 120, the transmission determination unit 116 determines the order in which the transmission determination processing is performed.

When reception responses from all of the clients 2 are obtained, the measuring unit 119 gives a reception report to the image processing unit 115. At this time, the image processing unit 115 sets an identifier in frame data. Thus, in the transmission determination process 103, the transmission determination unit 116 can determine whether the transmission target is a key frame or a non-key frame.

### Configuration of Client 2

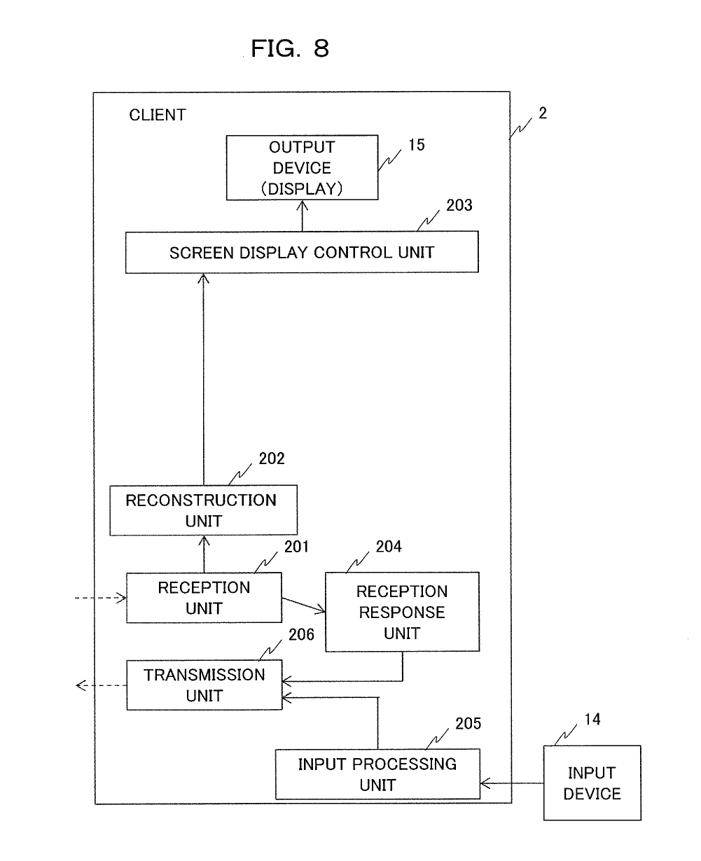

FIG. 8 is a diagram schematically illustrating a configuration example of the client 2. The information processing apparatus 10 that operates as the client 2 operates as an apparatus that includes the blocks illustrated in FIG. 8 when the processor 11 executes the program.

In FIG. 8, the client 2 operates as an apparatus including a reception unit 201, an image (screen data) reconstruction unit 202, a screen display control unit 203, an output device 15 (display), a reception response unit 204, an input processing unit 205 and a transmission unit 206.

The reconstruction unit 202, the screen display control unit 203, the reception response unit 204 and the input processing unit 205 are functions of the processor 11 obtained, for example, when the processor 11 executes a program. The reception unit 201 and the transmission unit 206 are functions possessed by the NIF 16.

The reception unit 201 receives frame data (key frame, non-key frame) transmitted from the server 1. The reconstruction unit 202 obtains screen data through reconstruction processing using frame data (compressed image or compressed image and difference image) received by the reception unit 201. The screen display control unit 203 performs drawing based on the reconstructed screen data on the VRAM, and outputs a video signal of the drawn screen to the output device (display) 15. The screen generated by the server 1 is thereby displayed on the output device 15 (display).

When the reception unit 201 receives a key frame, the reception response unit 204 generates a message of a reception response of the key frame and gives the message to the transmission unit 206. The transmission unit transmits the reception response to the server 1. Note that the address of the server 1 is assigned to the key frame as the source address and the address of the server 1 is set in the destination address of the reception response.

The input processing unit 205 generates operation information indicating contents of the operation inputted from the input device 14 for the screen displayed on the output device (display) 15 and transmits the operation information to the transmission unit 206. The transmission unit 206 transmits the operation information to the server 1.

### Processing Example of Server 1

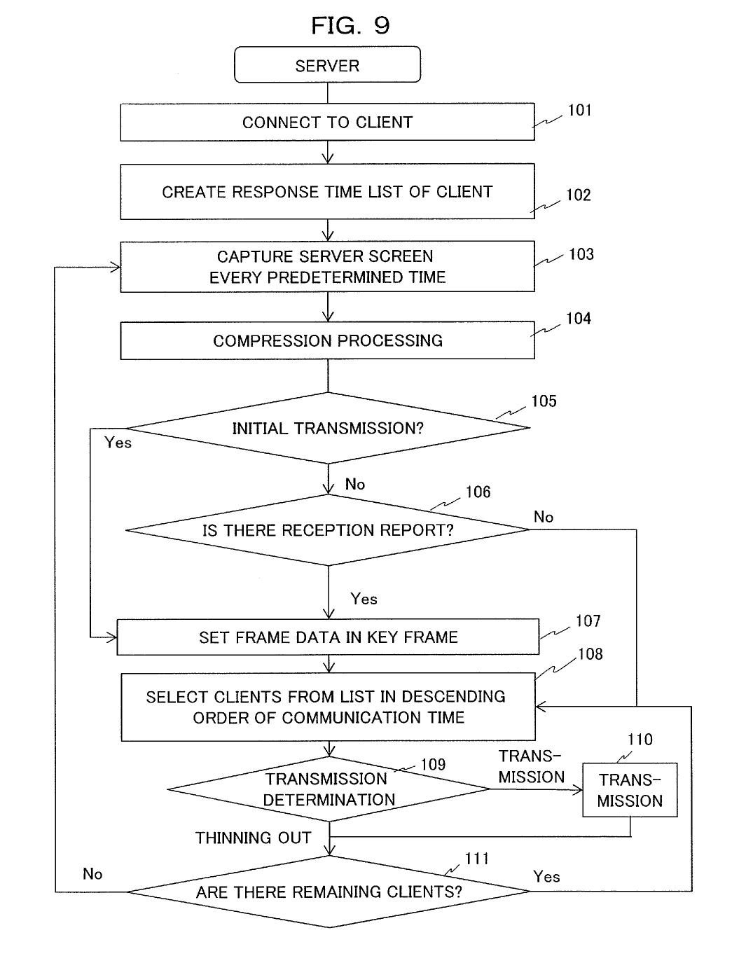

FIG. 9 is a flowchart indicating a processing example of the server 1. The processing illustrated in FIG. 9 is executed by the processor 11 (CPU) of the information processing apparatus 10 that operates as the server 1. In the example in FIG. 9, a compressed image is applied to initial frame data and a difference image is used for next and subsequent frame data. In the example in FIG. 9, whether or not the transmission target is a key frame is determined by the presence or absence of a reception report. Furthermore, in the example in FIG. 9, the reception response collection process 101 is executed by the processor 11 separately and the reception report is supplied to the transmission determination process 103.

In initial 101, the server 1 is connected to each client 2. Then, the processor 11 operates as the measuring unit 119 and creates the response time list 120 of each client 2 (102). The address of each client 2 is known to the server 1 (e.g., stored by the auxiliary storage device 13), and the processor 11 measures a response time (RTT) of each client using, for example, a ping command.

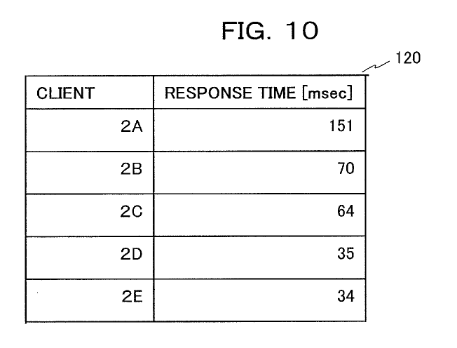

FIG. 10 illustrates a data structure example of the response time list 120. The response time list 120 is formed of, for example, an identifier of client 2 (user) and a set of entries including the response time (RTT). The identifier of the client 2 may be any kind of information capable of uniquely identifying the client, and may be a client ID, user name or an address of the client 2. Note that response times of the respective clients 2A to 2E illustrated in FIG. 10 are examples. As illustrated in FIG. 10, entries are sorted in descending order of response time and the entry order indicates the order in which the transmission determination processing is executed.

Returning to FIG. 9, in next 103, the processor 11 operates as the image acquisition unit 114 and captures a server screen (screen data) every predetermined time. Next, the processor 11 operates as the image processing unit 115 and generates a compressed image and a difference image by executing the compression process 102 (FIG. 4) (104). In the processing in 104 at the first time, a compressed image is generated and difference images are generated in the process in 104 from the second time on. Note that whether or not 104 is executed at the first time can be determined by, for example, management of a counter that counts the number of transmissions of frame data. However, the counting is not limited to such a technique.

In next 105, the processor 11 determines whether the frame data transmission this time is the first frame data transmission or not. If it is the first transmission (105, Yes), the process proceeds to 107 and if it is not the first transmission (105, No), the process proceeds to 106.

In 106, the processor 11 operates as the transmission determination unit 116 and determines whether or not it has received a reception report. If it has received the reception report (106, Yes), the process proceeds to 107 and if not (106, No), the process proceeds to 108.

In 107, the processor 11 sets frame data in the key frame. For example, an identifier indicating a key frame is assigned to the frame data. In next 108, the processor 11 selects one client from the response time list 120 (FIG. 10) in descending order of response time.

In next 109, the processor 11 operates as the transmission determination unit 116 and executes transmission determination processing. Details of the transmission determination processing are the same as those of the transmission determination process 103 described using FIG. 5, and therefore description thereof is omitted. As a result of the transmission determination processing, if transmission is performed, frame data is transmitted (110), and the frame data is transmitted from the transmission unit 117 (NIF 16). Then, the process proceeds to 111. In contrast, when the transmission is canceled (thinned out) as a result of the transmission determination processing, the process proceeds to 111.

In 111, the processor 11 determines whether there are remaining clients 2 or not. When there are remaining clients 2 (111, Yes), the process returns to 108 and the next client 2 is selected. In contrast, when there is no remaining client 2, that is, when the transmission determination processing (109) on all of the clients 2 has already been executed (111, No), the process returns to 103.

### Processing Example of Client

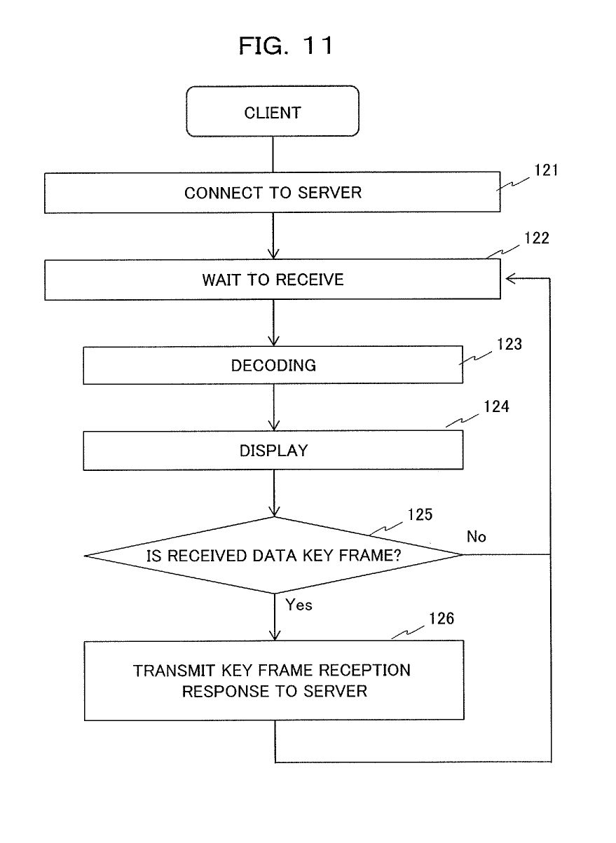

FIG. 11 is a flowchart illustrating a processing example of the client 2. The processing illustrated in FIG. 11 is executed by the processor 11 (CPU) of the information processing apparatus 10 which operates as the client 2.

In 121 at the first time, when the client 2 is connected to the server 1, the processor 11 waits to receive frame data from the server 1 (122). When the reception unit 201 (NIF 16) receives the frame data, the processor 11 operates as the reconstruction unit 202 and decodes the frame data using the technique already described (123). Next, the processor 11 operates as the screen display control unit 203 and causes the output device 15 (display) to display a screen based on the screen data obtained by decoding (124).

In 125, the processor 11 operates as the reception response unit 204 and determines whether the received data, that is, the received frame data is a key frame or not. Such a determination can be made depending on, for example, whether or not an identifier indicating a key frame is assigned to the frame data.

If the frame data is not a key frame (125, No), the process returns to 122 to wait to receive the next frame data. In contrast, if the frame data is a key frame (125, Yes), the processor 11 generates a message of a reception response of the key frame and transmits it to the server 1 (126). The reception response is transmitted from the transmission unit 206 (NIF 16) to the server 1. Then, the process returns to 122.

### Effects of Embodiment 1

According to Embodiment 1, the processor 11 of the server 1 transmits key frames to all of the plurality of clients 2, transmits non-key frames to the clients 2 for whom a communication environment between the clients 2 and the server satisfies a predetermined condition (where there are available bands) between transmissions of key frames and cancels transmission of non-key frames for the clients 2 for whom a communication environment does not satisfy the predetermined condition (where there are no available bands).

Thus, by carrying out transmission control on one piece of frame data, it is possible to transmit frame data for all of the clients 2 at a frame rate in accordance with the communication environment. Thus, it is possible to reduce the processing load of the server 1.

For each client 2, the processor 11 of the server 1 performs transmission determination processing in descending order of round trip times (response times) of transmitting a key frame if frame data to be transmitted is a key frame or transmitting a non-key frame if frame data to be transmitted is a non-key frame or canceling the transmission depending on whether or not a predetermined condition is satisfied. It is thereby possible to bring closer timings at which a screen (image) based on the key frame is displayed between the clients 2.

Furthermore, the processor 11 of the server 1 determines whether or not to transmit non-key frames depending on whether or not there is an available band to transmit non-key frames between the client 2 and the server 1. Therefore, when there is no available band, by canceling transmission of non-key frames, it is possible to prevent non-key frames from delaying in the network resulting in an increase in the difference in display timing between screens (images) based on key frames between the clients 2.

Furthermore, the processor 11 of the server 1 divides an accumulated data amount of key frames transmitted so far by an RTT relating to key frames transmitted so far as an estimate value (BWₘₐₓ) of the available band. The processor 11 transmits a non-key frame when the sum of the data amount of frame data for a period dating back by a unit time (1 second) from the current time and the data amount of the non-key frame to be transmitted falls below the estimate value, or cancels the transmission otherwise. By so doing, it is possible to determine whether or not to transmit a non-key frame in accordance with a change in the actual communication environment.

Furthermore, the processor 11 of the server 1 can transmit data (difference image) indicating a difference from the last transmitted key frame data as the non-key frame. It is thereby possible to reduce the size of frame data. That is, it is possible to reduce the amount of transfer data and reduce the load on the network 3 or the network 4.

Furthermore, the processor 11 of the server 1 can transmit data indicating a difference from the initially transmitted key frame as the key frame transmitted from the second time on. Thus, by transmitting data indicating the difference as the key frame, it is possible to further reduce the amount of transfer data.

Upon detecting that the last transmitted key frame is received by all of the plurality of clients 2 based on the response from each client 2, the processor 11 of the server 1 determines to transmit a key frame at transmission timing of transmitting the next frame data. This can prevent the transmission interval of key frames from unnecessarily extending.

### Modifications

Note that as has been illustrated in Embodiment 1, when a difference image is applied to frame data from the second time on, the server 1 and client 2 preferably perform the following processing. For example, when description is given based on the example illustrated in FIG. 3, when generating a frame #4, the server 1 extracts difference data between screen data at a point in time at which frame #1 is generated (referred to as “screen data #1”) and screen data at a point in time at which frame #4 is generated (referred to as “screen data #2”). The server 1 stores the screen data #2 in the main storage device 12 or auxiliary storage device 13 as a reference image to create a difference image of the non-key frame transmitted by the time the next key frame is transmitted.

When generating a frame #5, the server 1 captures screen data for generating the frame #5 (referred to as “screen data #3”), compresses the difference data from the saved screen data #2, generates and transmits a difference image (frame #5).

On the other hand, the client 2 that has received the frame #4 performs the following processing. That is, the client 2 reconstructs screen data using the frame #1 and the frame #4. The reconstructed screen data is stored in the main storage device 12 or auxiliary storage device 13 as data for reconstructing the frame #5. After that, when the frame #5 is received, difference data is obtained through expansion processing on the frame #5, synthesized with the saved reconstruction data and screen data equivalent to the screen data #3 is acquired. A screen based on this screen data is displayed on the output device 15.

At the time of transmission of a key frame from the second time on, the server 1 updates screen data used to create a difference image. On the other hand, the client 2 saves data for reconstruction, synthesizes the data for reconstruction and difference data obtained from the non-key frame and generates image data to be displayed. By so doing, the difference from the first key frame (frame #1) increases as the time passes, and it is thereby possible to prevent the data amount (size) of the difference image from increasing.

### Embodiment 2

Next, Embodiment 2 will be described. Since Embodiment 2 includes similarities to Embodiment 1, description of the similarities will be omitted and the following description will mainly focus on differences.

In Embodiment 1, the next frame data is set as a key frame at timing that reception responses from all of the clients 2 are obtained by the server 1. However, when even one remote (having a long response time) client 2 exists, the existence of such a client causes the key frame transmission interval (length of interval) to extend. In this case, as time passes from the key frame transmission time, the difference from the key frame increases and a compression ratio of a difference image transmitted as a non-key frame may deteriorate. The decrease in the compression ratio means an increase of the amount of transfer data. Embodiment 2 will describe a configuration to avoid such a problem.

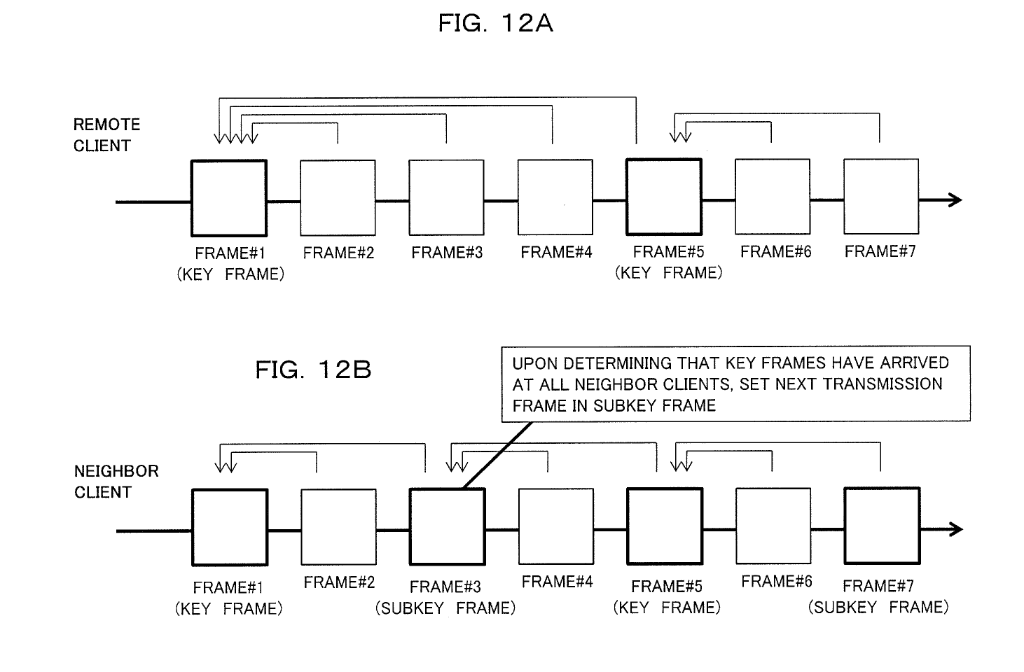

FIG. 12A and FIG. 12B are diagram illustrating Embodiment 2. FIG. 12A and FIG. 12B illustrate a plurality of rectangular blocks arranged on the time axis. Each block represents screen data captured by the server 1 for frame transmission. Arrows above the blocks represent screen data to be referenced to extract difference data. The screen data to be referenced is updated at timing of key frame transmission.

In the example illustrated in FIG. 12A, a frame #5 is the next key frame, and a frame #6 and a frame #7 are obtained by compressing difference data from screen data of the frame #5. This is the same as the technique illustrated in the modification of Embodiment 1. Here, it is assumed that the difference from the frame #1 (key frame) increases as the time passes.

In this case, the difference images generated by referencing screen data of the frame #5 are transmitted as the frame #6 and frame #7, and the data amounts of the frame #6 and frame 7 are thereby reduced. However, the difference between the frame #1 and the frame #4 is large and the data size of the frame #4 is large. On the other hand, reception responses of key frames from some of the plurality of clients 2 are assumed to have been received by the server 1 before transmission of the frame #3.

Thus, in Embodiment 2, the plurality of clients 2 are clustered according to reception timing of reception responses. For example, the plurality of clients 2 are clustered into two clusters of “remote clients” and “neighbor clients.” The “neighbor clients” are clients 2 whose reception responses have been received by the server 1 before transmission timing of the frame #3 and the “remote clients” are clients 2 other than the “neighbor clients.”

As illustrated in FIG. 12B, the server 1 sets the frame #3 as a subkey frame for “neighbor clients”. The subkey frame is a key frame which is effective not for all of the clients but for clients 2 belonging to a predetermined cluster. Screen data for reference is updated at timing of transmission of the subkey frame.

In the example in FIG. 12, the screen data of the frame #3 is set in the screen data for reference and the frame #4 corresponding to the “neighbor clients” becomes a difference image obtained by compressing the difference data from the screen data of the frame #3. This makes it possible to reduce the data amount of the frame #4 with respect to the “neighbor clients.” The frame #5 (key frame) with respect to the “neighbor clients” is also generated using the difference of the frame #3 from the screen data, and so the data amount is reduced. On the other hand, for the “remote clients,” the state illustrated in FIG. 12A is maintained.

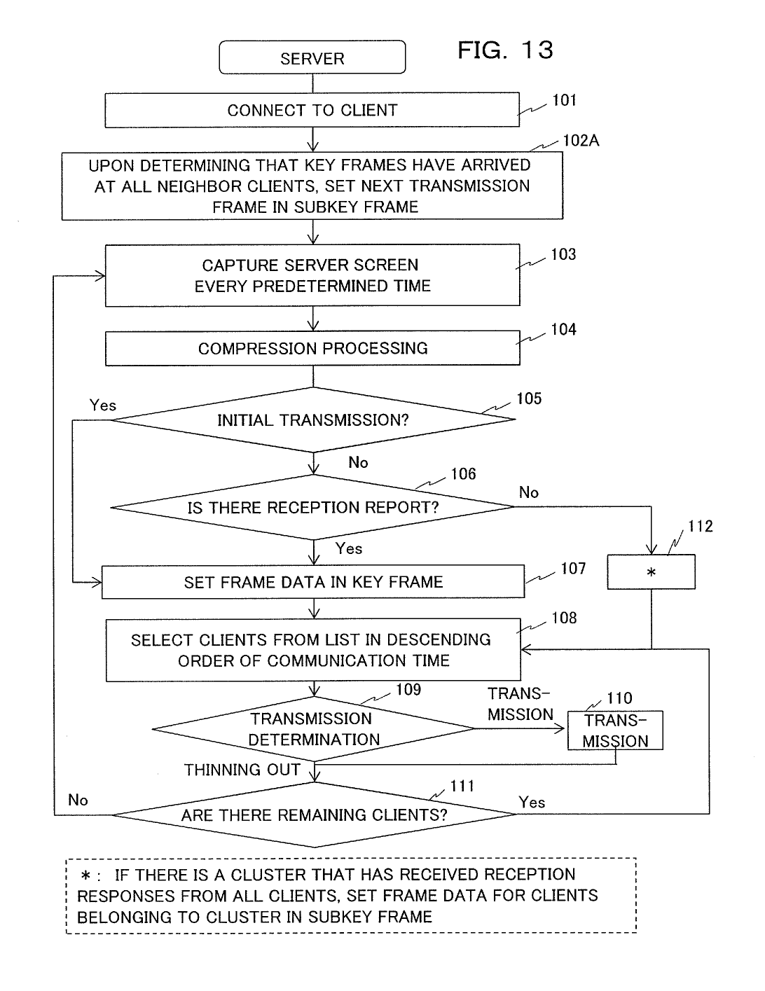

The above clustering and subkey frame setting are performed by the processor 11. FIG. 13 is a flowchart illustrating a processing example of the server 1 according to Embodiment 2. The processing of the server 1 illustrated in FIG. 13 is different from the processing of the server 1 illustrated in FIG. 9 in the following points. First, a process in 102A is provided instead of the process in 102. Second, a process in 112 is inserted between the process in 106 and the process in 108.

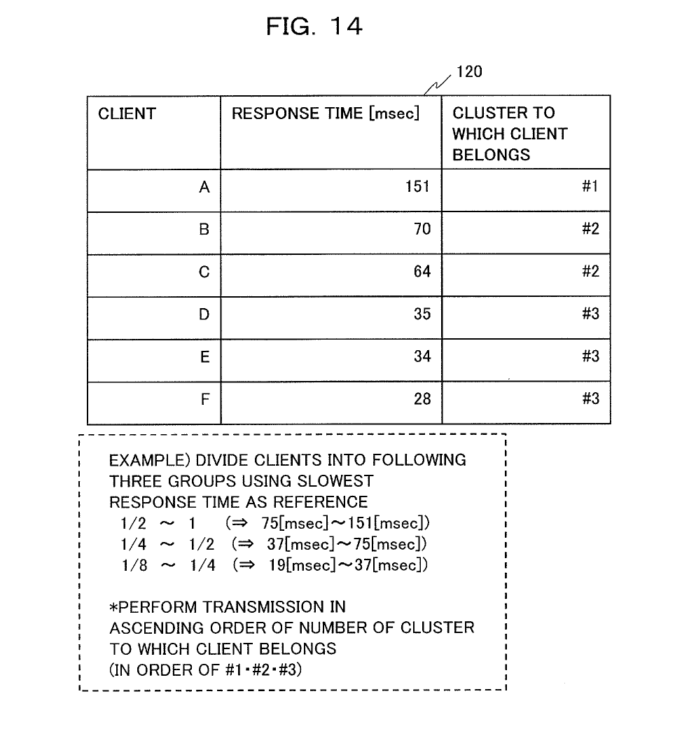

In 102A, the processor 11 creates a response time list 120 and clusters clients based on response times. FIG. 14 illustrates an example of the response time list 120 according to Embodiment 2.

The response time list illustrated in FIG. 14 includes information indicating a cluster to which the client 2 belongs in addition to the contents of the response time list illustrated in FIG. 10. In the example illustrated in FIG. 14, the clients 2 are clustered, for example, into three clusters (cluster #1, cluster #2, cluster #3) using the longest response time among all of the clients 2 as a reference.

Cluster #1 is a cluster to which the client 2 belongs, whose response time falls within a range of ½ to 1 of the longest response time. Cluster #2 is a cluster to which the client 2 belongs, whose response time falls within a range of ¼ to ½ of the longest response time. Cluster 1#3 is a cluster to which the client 2 belongs, whose response time falls within a range of ⅛ to ¼ of the longest response time.

In the process in 112 in FIG. 13, when there is a cluster that has received reception responses of key frames or reception responses of subkey frames from all of the clients 2, the processor 11 sets frame data for the clients 2 belonging to the cluster in the subkey frames.

For example, the processor 11 records reception situations of the reception responses of the key frames and the reception responses of the subkey frames from the respective clients 2 in the main storage device 12 or auxiliary storage device 13. The processor 11 determines whether or not the corresponding cluster exists with reference to the situation and the response time list (FIG. 14). In this case, if the corresponding plurality of clusters exist, frame data for the clients 2 belonging to the respective clusters are set in the subkey frame. The transmission processing is executed on clusters in descending order of response time.

The processes other than those in 102A and 112 in FIG. 13 are the same as those in Embodiment 1 (FIG. 9), and so description thereof is omitted.

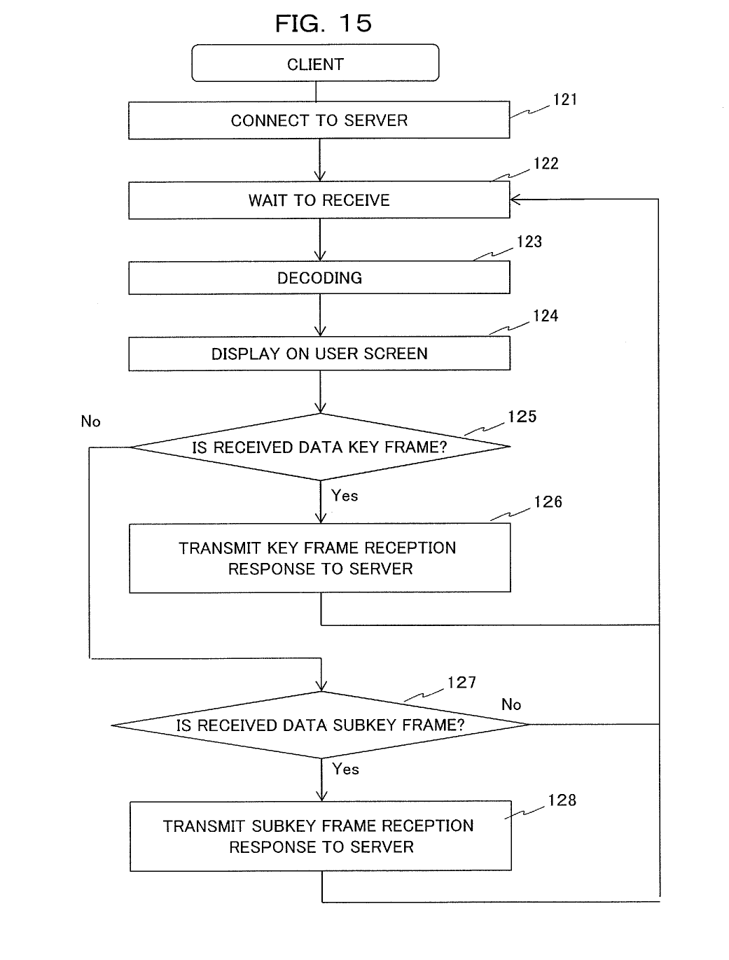

FIG. 15 is a flowchart illustrating a processing example of the client 2 according to Embodiment 2. The processing illustrated in FIG. 15 is different from the processing according to Embodiment 1 (FIG. 11) in that processes in 127 and 128 are added.

That is, when it is determined in the process in 125 in FIG. 15 that the received data is not a key frame (125, No), it is determined whether the received data is a subkey frame or not (127). In this case, if the received data is not the subkey frame (127, No), the process returns to 122. In contrast, if the received data is a subkey frame (127, Yes), the process proceeds to 128, a message of a reception response of a subkey frame is generated and the reception response of the subkey frame is transmitted to the server 1.

Except those described above, the processing illustrated in FIG. 15 is the same as that in FIG. 11, and so description thereof is omitted. Moreover, the configuration and operation of Embodiment 2 except those described above are substantially the same as those in Embodiment 1, and so description thereof is omitted.

In Embodiment 2, the processor 11 of the server 1 clusters the plurality of clients 2 into a plurality of clusters according to a round trip time (RTT) relating to the plurality of clients 2. If responses from all of the clients 2 belonging to a certain cluster are received before receiving responses indicating reception of key frames from all of the plurality of clients 2, the processor 11 determines to transmit subkey frames to all of the clients belonging to the certain cluster as transmission targets.

This makes it possible to avoid deterioration of a compression ratio of the frame data for the clients 2 having a relatively short RTT. In other words, by clustering of the clients 2 and subkey frame setting, it is possible to increase the compression ratio of the frame data transmitted to some clients 2.

### Embodiment 3

Next, Embodiment 3 will be described. Since Embodiment 3 includes similarities to Embodiment 1, description of the similarities is omitted and the description will mainly focus on differences. In Embodiment 1 and Embodiment 2, transmission processing on the clients 2 is executed in descending order of response time.

As has been described in Embodiment 1, operation information from each client 2 is sent to the server 1, the server 1 updates screen data that reflects the operation information and the screen data is transmitted to each client 2. In this case, if the client 2 that transmits the operation information takes time to update the screen associated with the operation, it is impossible to give the operator a good operation feeling. Thus, according to Embodiment 3, when the server 1 receives operation information, priority of transmission processing for the client 2 which is the source of the operation information is raised.

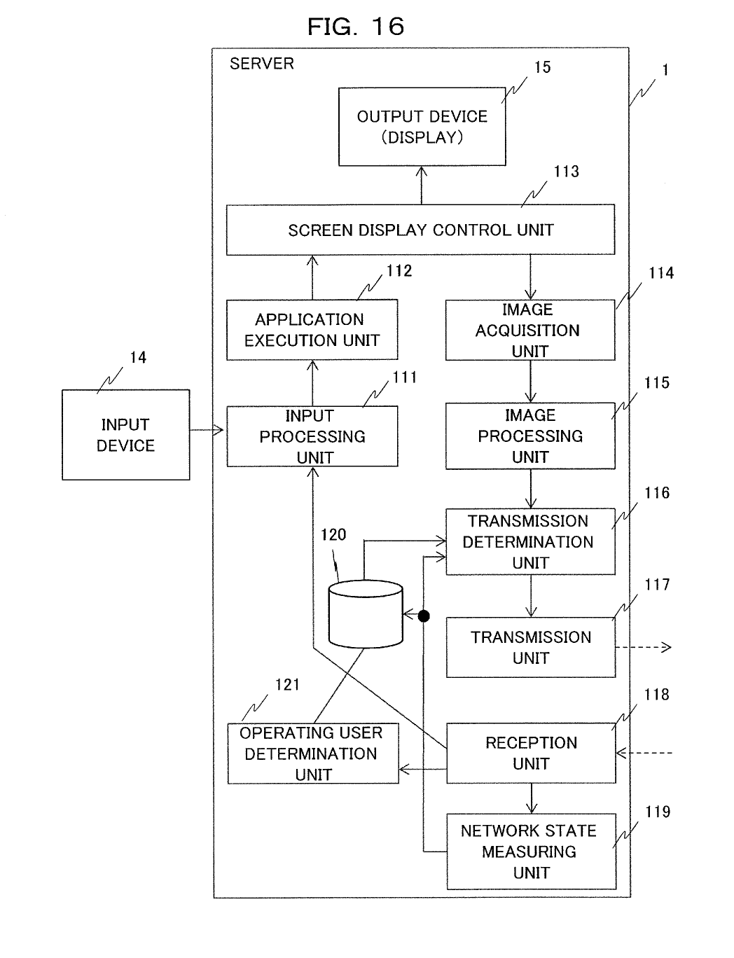

FIG. 16 is a diagram schematically illustrating a configuration example of the server 1 according to Embodiment 3. The server 1 illustrated in FIG. 16 is further provided with an operating user determination unit 121 in addition to the configuration of Embodiment 1 (FIG. 7).

When the reception unit 118 receives operation information, the operating user determination unit 121 obtains an identifier of the source client 2 of the operation information from the reception unit 118. The operating user determination unit 121 changes entry registration order of the response time list 120 so that the entry of the source client 2 comes first.

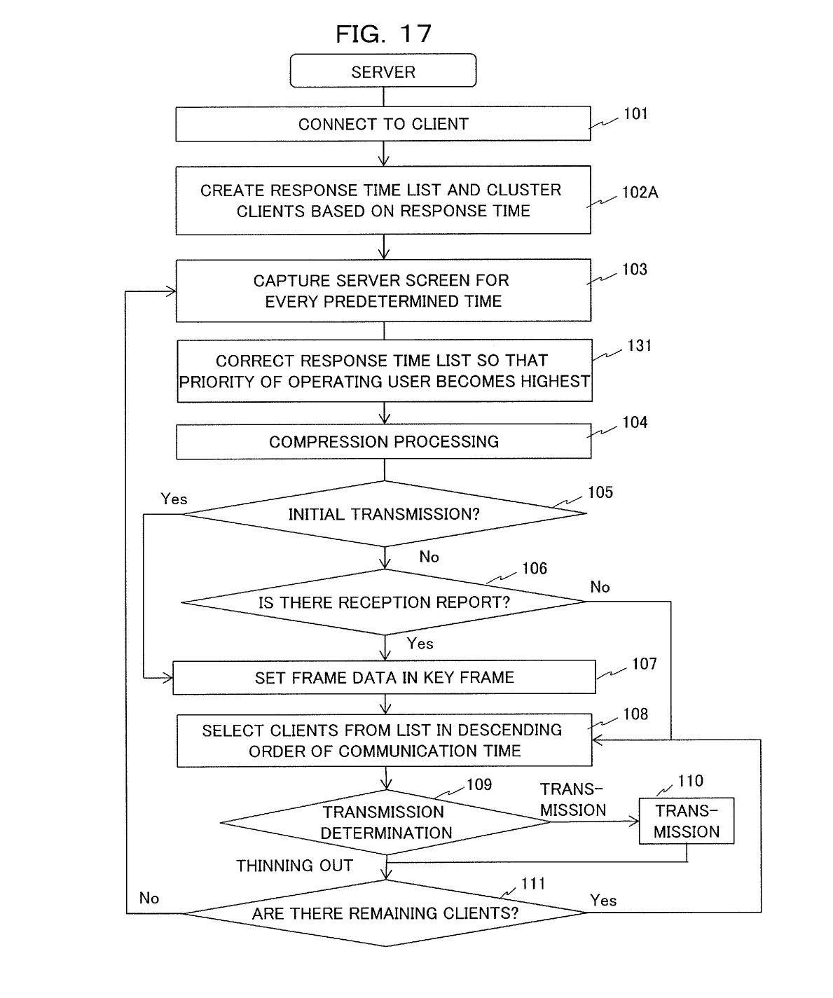

FIG. 17 is a flowchart illustrating a processing example of the server 1 according to Embodiment 3. The processing illustrated in FIG. 17 is different from the processing in Embodiment 1 (FIG. 9) in the following points. First, a process in 131 is inserted between the process in 103 and the process in 104. Second, a process in 108A is provided instead of the process in 108.

In 131, the processor 11 corrects the entry registration order of the response time list 120 so that priority of transmission determination processing of the operating user (client 2 as the source of operation information) is raised. In the example of Embodiment 3, correction is made so that the priority of the operating user becomes the highest. However, it is not indispensable that the priority be set to the highest.

In 108A, the processor 11 selects the client 2 whose priority is the highest (with top priority) from the response time list as a target of the transmission determination process 103 (process in 109). However, since the client 2 registered as the first entry of the response time list 120 is selected as the first target of transmission determination processing, the process in 108 is not substantially different from the process in 108A as the processing of the processor 11.

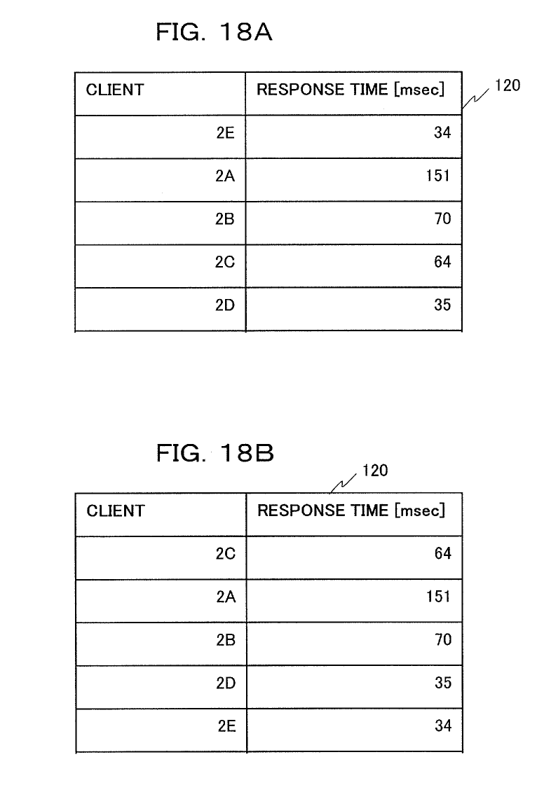

FIG. 18A and FIG. 18B illustrate registration contents examples of the response time list 120 corrected by the process in 131. When there is no operation information (initial state), as registration contents of the response time list 120, entries of the clients 2A to 2E are registered in descending order of response time as illustrated in FIG. 14. In contrast, when operation information from the client 2E is received, for example, the registration position of the entry of the client 2E is changed to the top as illustrated in FIG. 18A. As described above, since the transmission determination processing is performed in entry registration order of the response time list 120, the transmission determination processing on the client 2E is performed first.

FIG. 18B illustrates a case where after starting transmission determination processing on the client 2E, operation information is received from the client 2C. In this case, the entry of the client 2C moves to the top. The entry of the client 2E is returned to the bottom according to the length of the response time. Thus, the transmission determination processing on the client 2C is executed preferentially. Note that when the transmission determination processing on the client 2C starts, the entry of the client 2C returns to its original position. That is, the registration contents return to the state in FIG. 14.

Since processes other than those in 131 and 108A in FIG. 17 are the same as the processes in FIG. 9, description thereof is omitted. Moreover, the rest of the configuration in Embodiment 3 is the same as Embodiment 1, and so description thereof is omitted.

In Embodiment 3, when operation information on the screen is received, the processor 11 of the server 1 raises priority of the transmission determination processing on the client 2 as the source of the operation information. It is thereby possible to advance timing at which frame data reflecting operation information for the client 2 is transmitted. This makes it possible to improve the operation feeling perceived by the operator of the client 2 as the source of the operation information.

Note that the configuration of Embodiment 3 can be combined with Embodiment 2. In addition, the configurations illustrated in Embodiment 1, Embodiment 2 and Embodiment 3 can be combined as appropriate. According to the embodiments, it may provide a technique capable of reducing processing load of a server.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for distributing frame data of an image to a plurality of clients via a network, the method comprising:
generating, using a processor, first frame data and second frame data as the frame data;
transmitting, using the processor, the first frame data to all of the plurality of clients; and
transmitting, using the processor, the second frame data to clients for whom a communication environment between the clients and the server satisfies a predetermined condition between the transmissions of the first frame data.

2. The method for distributing frame data of an image according to claim 1, wherein the processor executes transmission determination processing on each client in descending order of return trip delay time, the transmission determination processing including:
transmitting the first frame data when frame data to be transmitted is the first frame data; and
transmitting the second frame data or canceling the transmission when the frame data to be transmitted is the second frame data depending on whether the predetermined condition is satisfied or not.

3. The method for distributing frame data of an image according to claim 1, wherein the processor determines on each client whether the predetermined condition is satisfied or not depending on whether there is an available band in the network to transmit the second frame data between the client and the server.

4. The method for a server distributing frame data of an image according to claim 3, wherein the processor calculates a value obtained by dividing an accumulated data amount of the first frame data transmitted so far by a round trip time relating to the first frame data transmitted so far as an estimate value of an available band, transmits the second frame data when the sum of the data amount of frame data for a period dating back by a unit time from the current time and the data amount of the second frame data to be transmitted falls below the estimate value, or cancels the transmission of the second frame data.

5. The method for distributing frame data of an image according to claim 1, wherein the processor transmits data indicating a difference from the last transmitted first frame data as the second frame data.

6. The method for distributing frame data of an image according to claim 1, wherein the processor transmits data indicating a difference from the initially transmitted first frame data as the first frame data to be transmitted from the second time on.

7. The method for distributing frame data of an image according to claim 1, wherein the processor determines to transmit the first frame data at the next frame data transmission timing when detecting that the last transmitted first frame data is received by all of the plurality of clients based on a response from each client.

8. The method for distributing frame data of an image according to claim 1, wherein the processor clusters the plurality of clients into a plurality of clusters in accordance with round trip times relating to the plurality of clients, and
determines to transmit third frame data to all of the clients belonging to a certain cluster when the responses are received from all of the clients belonging to the certain cluster before receiving responses indicating reception of the first frame data from all of the plurality of clients.

9. The method for distributing frame data of an image according to claim 2, wherein the processor receives operation information on the image and raises priority of the transmission determination processing on a client who is a source of the operation information.

10. A non-transitory computer readable recording medium having stored therein a program for causing a computer to execute a process for distributing frame data of an image to a plurality of clients via a network, the process comprising:
generating first frame data and second frame data as the frame data;
transmitting the first frame data to all of the plurality of clients; and
transmitting the second frame data to clients for whom a communication environment between the clients and the server satisfies a predetermined condition between the transmissions of the first frame data.

11. A server that distributes frame data of an image to a plurality of clients via a network, the server comprising:
a control apparatus configured to execute a process including:
generating first frame data and second frame data as the frame data;
transmitting the first frame data to all of the plurality of clients; and
transmitting the second frame data to clients for whom a communication environment between the clients and the server satisfies a predetermined condition between the transmissions of the first frame data.
